(19) United States
(12) Patent Application Publication
(10) Pub. No.: US 2010/0320184 A1
(43) Pub. Date: Dec. 23, 2010

(54) WELDING CONTACT TIP AND WELDING GUN INCORPORATING THE SAME

(75) Inventors: Edward Enyedy, Eastlake, OH (US); Todd E. Kooken, Solon, OH (US); Steven Peters, Huntsburg, OH (US); Keith Clark, Concord, OH (US); Vaidyanath Rajan, Mentor, OH (US)

Correspondence Address: Lincoln Electric Company/Perkins COIE LLP, 607 Fourteenth Street , NW, Washington, DC, 20005-2003, US

(73) Assignee: LINCOLN GLOBAL, INC., City of Industry, CA (US)

(21) Appl. No.: 12/488,053

(22) Filed: Jun. 19, 2009

(51) Int. Cl. B23K 9/00

(52) U.S. Cl. 219/136

(57) ABSTRACT

A welding contact tip having a body portion and bore passing through the body portion. The welding contact tip is made from an alloy which comprises diamonds and/or diamond powder.

### BACKGROUND OF THE INVENTION

1. Field of the Invention

Devices, systems, and methods consistent with the invention relate to an improved welding contact tip and a welding gun comprising the same.

2. Description of the Related Art

In most current welding applications and welding gun is used in the welding process through which the welding electrode passes to the work piece. This is particular true in gas metal arc welding (GMAW), submerged arc welding (SAW) and flux cored arc welding (FCAW). The welding gun can be coupled to an electrode supply source, such as a wire feeder, a power source which provide the welding current and voltage, and a welding gas supply to provide a shielding gas.

During operation, the welding electrode is advanced toward and through the welding gun. Within the welding gun is a contact tip through which the electrode passes. In a typical welding gun the welding waveform (current and voltage) from the welding power source is directed through the contact tip to the electrode for the welding operation. Those of skill in the art are well familiar with the use and implementation of contact tips within a welding gun.

Because the contact tip is employed to transmit an electrical signal it is typically made from an electrically conductive material, such as copper. However, the need to make contact tips from electrically conductive materials renders them susceptible to wear during welding, thus requiring constant replacement. During the welding operation, contact tips are exposed to very high heat levels, constant frictional wear from the electrode passing through the contact tip and micro-arcing between surfaces of the contact tip and the electrode. These conditions cause contact tips to degrade in such a way as to require constant replacement, particularly in high use applications. Replacement of the contact tips causes down time in which the welding apparatus can not be used.

Various metal alloys have been used to provide sufficient wear resistance while at the same time providing sufficient electrical conductivity and heat transfer characteristics. However, improvements are still required as these alloys can still result in the repeated and frequent need of replacement.

Accordingly, a contact tip is needed which provides improved wear resistance while at the same time providing sufficient thermal and electrical conductivity.

### BRIEF SUMMARY OF THE INVENTION

An exemplary embodiment of the present invention is a welding contact tip which contains a body portion and a bore passing through the body portion, where the welding contact tip contains at least diamonds and/or diamond powder.

### BRIEF DESCRIPTION OF THE DRAWINGS

The above and/or other aspects of the invention will be more apparent by describing in detail exemplary embodiments of the invention with reference to the accompanying drawings, in which:

FIG. 1 illustrates a diagrammatical representation of a contact tip in accordance with an exemplary embodiment of the present invention;

FIG. 2 illustrates a diagrammatical representation of a contact tip in accordance with another exemplary embodiment of the present invention;

FIG. 3 illustrates a diagrammatical representation a welding gun in accordance with an exemplary embodiment of the present invention.

### DETAILED DESCRIPTION OF EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

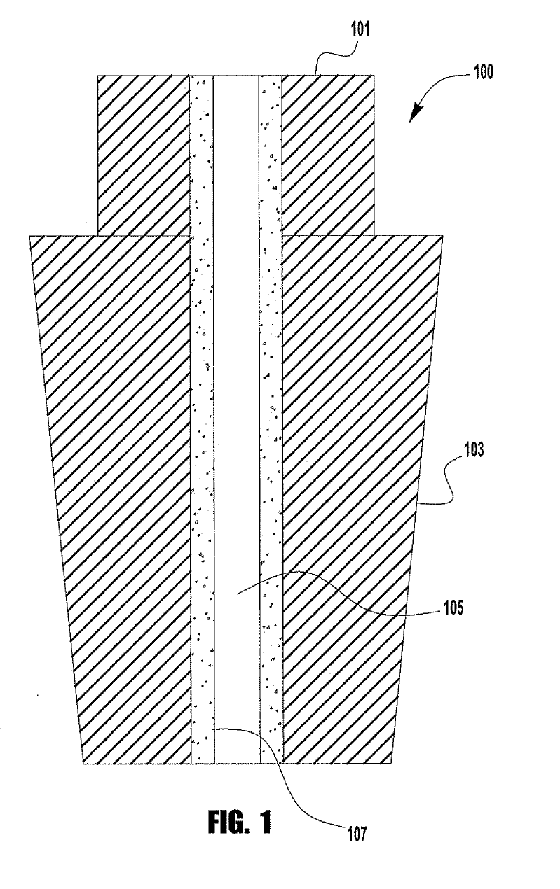

FIG. 1 depicts a contact tip 100 in accordance with an exemplary embodiment of the present invention. FIG. 1 shows a cross-section of the contact tip 100 for clarity of the following discussion. Additionally, it is noted that the present invention is not limited in any way regarding the overall shape or geometry of the contact tip 100. The shape shown in FIG. 1 is merely representative.

In the exemplary embodiment shown in FIG. 1, the contact tip 100 comprises a thread portion 101 and a body portion 103. The thread portion 101 is coupled to the body portion 103, integrally or otherwise. The thread portion 101 may have on its outer surface threads to allow the contact tip 100 to be secured to a welding gun, which will be described in more detail below.

Through the length of the contact tip 100 is an inner bore 105. During operation the welding electrode passes through the bore 105. The bore 105 has a diameter (it is typically circular in cross-section) which is designed to be compatible with the size or sizes of electrodes to be used. In the exemplary embodiment shown in FIG. 1 the bore 105 has a bore layer 107 which is coated with diamonds and/or a diamond powder.

As is widely know, diamonds are a very hard substance with strong resistance to wear, such as by frictional contact. Additionally, diamonds conduct electricity as well as heat in such a way such that they can be employed in welding contact tips to provide greatly increased wear resistance without a compromise in thermal or electrical conductivity. In accordance with various exemplary embodiments of the present invention both naturally occurring and man made diamonds can be used.

In an exemplary embodiment of the present invention, the bore layer 107 is entirely coated with diamonds and/or diamond powder such that any electrode passing through the bore 105 only makes contact with the diamonds. The thickness of the layer 107 is to be optimized based on the desired electrical conductivity and thermal resistance performance.

In an exemplary embodiment, the surface 107 can be completely covered in diamonds which have a relatively small grain size so as to ensure that the diamonds do not scratch or otherwise score the electrode during operation. In another embodiment, the bore layer 107 is coated with a diamond powder. In a further exemplary embodiment the bore layer 107 comprises both diamonds and diamond powder. The ratio of diamonds to diamond powder should be optimized based on the desired performance characteristics of the tip 100.

In an exemplary embodiment, the diamonds and/or diamond powder is secured in the bore layer 107 by being impregnated in the alloy which makes up the remainder of contact tip 100. For example, if the contact tip is made with copper or a copper alloy the bore layer 107 is made up of diamonds and/or diamond powder which is impregnated into the alloy so as to secure the diamonds and diamond powder.

In another exemplary embodiment of the present invention the bore layer 107 can be removable/replaceable component of the contact tip 100. For example, it is contemplated that the bore layer 107 can be a cylindrical insert which can be removed when it becomes worn and replaced with a new bore layer 107. In an exemplary embodiment, the removable bore layer 107 can be made with threads on an outer surface thereof such that it can be screwed into the contact tip 100. In another embodiment, the bore layer 107 can be made such that it can be press fit or friction fit into the contact tip 100. Various other methods to secure the bore layer 107 to the contact tip 100 may be used without departing from the scope or spirit of the present invention.

In a further exemplary embodiment of the present invention (not specifically shown) the bore layer 107 does not extend the entire length of the tip 100. For example, in an alternative embodiment of the present invention, the bore layer 107 extends up to approximately 50% of the length of the bore 105 from the end of the contact tip 100 through which the electrode exits the contact tip 100. In another exemplary embodiment, the bore layer 107 extends up to approximately 25% of the length of the bore 105.

In a further exemplary embodiment of the present invention, other materials or minerals having similar heat and wear resistance and electrical conductive attributes as diamonds may be used in conjunction with, or as a replacement to diamonds. For example, it is contemplated that various embodiments of the present invention employ tungsten and/or carbon. In fact, it is contemplated that various embodiments of the present invention employ a combination of any one or more of diamonds, tungsten and carbon in the bore layer 107. In embodiments where two or more of these components are employed their respective ratios are to be optimized based on the desired performance characteristics.

It is noted that both tungsten and carbon may have a tendency to oxidize at higher operational temperatures. Therefore, this should be taken into account when determining the composition of the bore layer 107. For example, to minimize oxidation it is contemplated that tungsten and/or carbon can be used in contact tips 100 which are not exposed to oxygen in a shielding gas during operation. For example, submerged-arc welding.

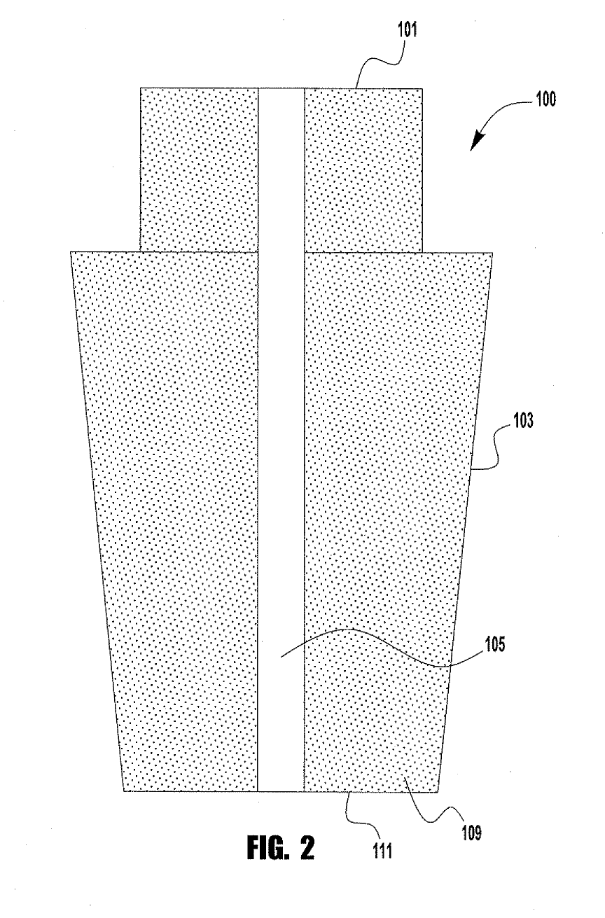

FIG. 2 depicts another exemplary embodiment of the present invention. In this embodiment the contact tip 100 is made from an alloy material 109 in which the diamonds and/or diamond powder is distributed throughout the contact tip 100. For example, in an exemplary embodiment the diamonds and/or diamond powder are distributed uniformly within the contact tip alloy 109. In another exemplary embodiment, the concentration of diamonds and/or diamond powder near the wall of the bore 105 is higher than that in the rest of the contact tip 100. In such an embodiment, the higher concentration of diamonds and/or diamond powder near the bore 105 provides higher wear resistance. In such an embodiment, the distribution of diamonds/diamond powder within the contact tip 100 is optimized because the wear resistance at the bore 105 is high while the remaining distribution is low to reduce cost.

In an exemplary embodiment, the concentration of the diamonds/diamond powder at the wall of the bore is at least 50% higher than the concentration throughout the remainder of the contact tip.

Similar to the embodiment depicted in FIG. 1, in another exemplary embodiment of the present invention, even though the alloy 109 contains diamonds and/or diamond powder as shown in FIG. 2, a removable/replaceable bore layer 107, as discussed above regarding FIG. 1, may be employed. In such an embodiment the bore layer 107 can have the same concentration as the alloy 109 or it can be different from the alloy (for example, it may have a higher concentration).

In a further exemplary embodiment, as discussed with respect to FIG. 1, other materials may be employed in conjunction with, or as a replacement for the diamonds. For example, it is contemplated that embodiments of the present invention may use carbon and/or tungsten as an alternative or in conjunction with diamonds and/or diamond powder within the alloy 109. The ratio of the components selected is to be optimized based on desired performance characteristics. That is, if tungsten and diamonds are employed, the relative concentration of each within the alloy 109 should be optimized.

In other exemplary embodiments of the present invention, different metals can be used as a replacement for, or in conjunction with, the copper discussed above. For example, it is contemplated that alloys made from beryllium, chrome, zirconium, silver and tungsten, in addition to copper, can be used. These alloys can be used individually or in combination with each other in the contact tip 100.

In another exemplary embodiment of the present invention, the concentration of the diamonds/diamond powder is increased at a tip portion 111 of the contact tip 100. Because the tip portion 111 is closest to welding arc the heat exposure is the highest at the tip portion 111. Thus, an increased concentration of diamonds/diamond powder at the tip portion 111 aids in the wear resistance of the contact tip 100. In an exemplary embodiment, the concentration of the diamonds/diamond powder at the tip portion 111 is at least 50% higher than the concentration throughout the remainder of the contact tip 100.

In a further exemplary embodiment of the present invention, it is contemplated that when employing a mixture of carbon and/or tungsten and diamonds, the relative concentration of diamonds is higher nearer to the tip portion 111 of the contact tip 100. That is, if tungsten and diamonds are employed in the alloy 109, the concentration of diamonds in the alloy 109 at the tip portion 111 will be higher than the remainder of the alloy 109.

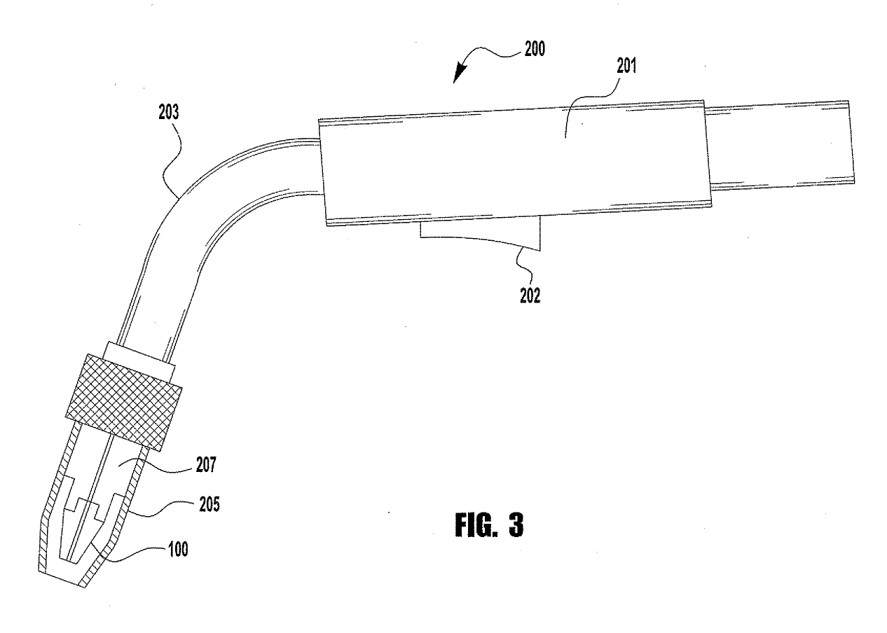

Turning now to FIG. 3, a welding gun 200 in accordance with an exemplary embodiment of the present invention is shown. As an initial matter, it is noted that a detailed discussion of a welding gun assembly will not be included herein as those of ordinary skill in the art are well familiar with the design, structure and assembly of welding guns.

As shown in FIG. 3, the exemplary embodiment of the welding gun 200 contains a handle portion 201, which typically contains a trigger assembly 202. The trigger assembly 202 is used to activate the feeding of the welding electrode and the power supply to begin the welding operation. Coupled to the handle portion 201 is a goose neck portion 203. The goose neck portion 203 is typically bent as shown, so as to allow for ergonomic operation of the welding gun 200.

Coupled to the goose neck portion 203 is a nozzle 205 and within the nozzle 205 is a conductive assembly 207 to which the contact tip 100 is coupled. (It is noted that for clarity the nozzle 205, conductive assembly 207 and contact tip 100 are shown in cross-section.) The conductive assembly 207 is electrically coupled to the power supply via electrical leads (not shown). Because the conductive assembly 207 is electrically conductive the waveform is passed through the conductive assembly 207 through the contact tip 100 and into the welding electrode (not shown). The contact tip 100 is secured to the conductive assembly 207 via the thread portion 101 of the contact tip 100. Additionally, the conductive assembly 207 has a diffuser portion (not shown) through which a shielding gas passes and enters the cavity created by the nozzle 205 and is directed towards the welding operation.

It is noted that the welding gun of the present invention in not limited to the embodiment of the welding gun 200 shown in FIG. 3. The depicted welding gun 200 is intended to be exemplary in nature. Specifically, it is contemplated that the welding gun of the present invention can be of the type employed with GMAW, SAW, and/or FCAW, as well as any other types of welding guns or devices in which a contact tip is employed.

While the invention has been particularly shown and described with reference to exemplary embodiments thereof, the invention is not limited to these embodiments. It will be understood by those of ordinary skill in the art that various changes in form and details may be made therein without departing from the spirit and scope of the invention as defined by the following claims.

What is claimed is:

1. A welding contact tip, comprising:
a body portion; and
a bore passing through said body portion,
wherein said welding contact tip comprises at least one of diamonds and diamond powder.

2. The welding contact tip of claim 1, wherein said bore has a bore layer and said bore layer comprises at least one of diamonds and diamond powder.

3. The welding contact tip of claim 1, wherein said body portion contains copper or a copper alloy and said at least one of diamonds and diamond powder is impregnated into said copper or copper alloy.

4. The welding contact tip of claim 1, further comprising a bore layer which is positioned within said bore and said bore layer contains at least some of said at least one of diamonds and diamond powder.

5. The welding contact tip of claim 4, wherein said bore layer is removable from said bore.

6. The welding contact tip of claim 4, wherein said bore layer extends up to 50% of the length of said bore.

7. The welding contact tip of claim 4, wherein said bore layer extends up to 25% of the length of said bore.

8. The welding contact tip of claim 1, wherein a concentration of said at least one of diamonds and diamond powder adjacent to said bore is higher than a concentration of said diamonds and diamond powder remote from said bore.

9. The welding contact tip of claim 1, wherein a concentration of said at least one of diamonds and diamond powder adjacent to a tip portion of said contact tip is higher than a concentration of said diamonds and diamond powder remote from said contact tip.

10. A welding contact tip, comprising:
a body portion; and
a bore passing through said body portion,
wherein said welding contact tip comprises at least one of diamonds and diamond powder and at least one of tungsten and carbon.

11. The welding contact tip of claim 10, wherein said bore has a bore layer and said bore layer comprises at least one of diamonds and diamond powder.

12. The welding contact tip of claim 10, wherein said body portion contains copper or a copper alloy and said at least one of diamonds and diamond powder is impregnated into said copper or copper alloy.

13. The welding contact tip of claim 10, further comprising a bore layer which is positioned within said bore and said bore layer contains at least some of said at least one of diamonds and diamond powder.

14. The welding contact tip of claim 13, wherein said bore layer is removable from said bore.

15. The welding contact tip of claim 13, wherein said bore layer extends up to 50% of the length of said bore.

16. The welding contact tip of claim 13, wherein said bore layer extends up to 25% of the length of said bore.

17. The welding contact tip of claim 10, wherein a concentration of said at least one of diamonds and diamond powder adjacent to said bore is higher than a concentration of said diamonds and diamond powder remote from said bore.

18. The welding contact tip of claim 10, wherein a concentration of said at least one of diamonds and diamond powder adjacent to a tip portion of said contact tip is higher than a concentration of said diamonds and diamond powder remote from said contact tip.

19. A welding contact tip, comprising:
a body portion; and
a bore passing through said body portion,
wherein said bore has a bore layer and said bore layer comprises tungsten.

20. A welding gun, comprising:
a welding contact tip, said contact tip comprising:
a body portion; and
a bore passing through said body portion,
wherein said welding contact tip comprises at least one of diamonds and diamond powder.

21. A welding gun, comprising:
a welding contact tip, said contact tip comprising:
a body portion; and
a bore passing through said body portion,
wherein said welding contact tip comprises at least one of diamonds and diamond powder and at least one of tungsten and carbon.
